(19) United States
(12) Patent Application Publication
(10) Pub. No.: US 2006/0243282 A1
(43) Pub. Date: Nov. 2, 2006

(54) Automated oxygen hose reel

(76) Inventors: Susan M. Sackman, St. Paul, MN (US); Peggy S. Quirk, Maple Grove, MN (US); David A. Crawford, Pine City, MN (US); George Lupambo, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/415,448

(22) Filed: May 1, 2006

Related U.S. Application Data
(60) Provisional application No. 60/676,435, filed on Apr. 29, 2005.

(51) Int. Cl. A62B 9/00

(52) U.S. Cl. 128/205.22

(57) ABSTRACT

An oxygen hose reel assembly having improved safety and usability features. The oxygen hose reel assembly can include automated mechanical and/or electrical systems for dispensing or recoiling oxygen tubing. The oxygen hose reel assembly can incorporate a lightweight, integral design such that the oxygen hose reel assembly is readily adapted for use in a variety of locations and can be portable between differing locations. The oxygen hose reel assembly can include control means providing a patient the ability to operate the oxygen hose reel assembly remotely. The oxygen hose reel assembly can further include a hose mechanism for accommodating hose related stresses such that these stresses are not translated to the patient.

### PRIORITY CLAIM

The present application claims priority to U.S. Provisional Application Ser. No. 60/676,435 filed Apr. 29, 2005 and entitled “AUTOMATED OXYGEN HOSE REEL”, which is herein incorporated by reference in its entirety.

### FIELD OF THE INVENTION

The invention relates generally to the field of tubing reels. More particularly, the present invention pertains to an automated assembly for providing increased functionality and safety to hose reel assemblies for dispensing and retracting oxygen tubing.

### BACKGROUND OF THE INVENTION

For a variety of medical reasons, both ambulatory and non-ambulatory patients can be prescribed an around-the-clock regiment of therapeutic gas, most commonly oxygen. Often these patients suffer from ailments such as, for example, emphysema, which limits the function and/or capacity of the respiratory system. As such, the introduction of concentrated oxygen by placement of an oxygen hose in proximity to the patient's nose can help to restore the body's oxygen level and to reduce incidents of fatigue and light headedness.

In general, the oxygen hose can be connected to an oxygen source such as, for example, individual bottles of oxygen or an oxygen concentrator. Typically, a length of oxygen hose is wrapped around a hose reel so as to provide the patient or health care professional with the ability to vary the length of the oxygen hose that is unspooled from the hose reel. Examples of representative hose reels are as described in U.S. Pat. No. 5,975,120 to Novosel, U.S. Pat. No. 6,065,490 to Falcone, Jr., U.S. Pat. No. 6,588,444 to Paplow et al. and U.S. Pat. No. 6,591,858 to Peterson, all of which are herein incorporated by reference in their entirety.

The length of the unspooled oxygen hose is especially important for ambulatory patients who must perform common tasks and activities while wearing their oxygen hose. For instance, ambulatory patients who utilize an oxygen hose at home may at times need upwards of 50 feet or more of tubing so as to allow the patient to move throughout their home. The unspooled tubing can create potential hazards for the wearer in that the potential exists for the tubing to become caught or wrapped around furniture, corners, doors, etc., which can lead to unexpected tugs and jerks on the wearer. In addition, the unspooled tubing can be a tripping hazard for the patient and/or other individuals in the home.

What is needed is an oxygen hose reel that incorporates operational and safety features allowing both ambulatory and non-ambulatory patients to safely and conveniently manage their oxygen hose.

### SUMMARY OF THE INVENTION

The present disclosure addresses an oxygen hose reel assembly having features promoting safety and usability. The oxygen hose reel assembly can comprise an automated mechanical and/or electrical system for recoiling or dispensing oxygen tubing. The oxygen hose reel assembly can incorporate a lightweight, integral design such that the oxygen hose reel assembly is readily adapted for use in a variety of locations. The oxygen hose reel assembly can comprise a control means providing a patient with the ability to operate the oxygen hose reel assembly remotely. The oxygen hose reel assembly can comprise a hose mechanism for accommodating hose related stresses such that these stresses are not translated through the hose to the patient.

In one aspect, an oxygen hose reel assembly of the present invention can comprise a lightweight, portable design such that the oxygen hose reel assembly can be positioned as desired by a patient or caregiver. The oxygen hose reel assembly can comprise a handle allowing the assembly to be hand carried and positioned to accommodate the needs of a patient. The oxygen hose reel assembly can comprise a mounting bracket allowing the assembly to be mounted in proximity to the user such as, for example, on a wheelchair, bed or directly to an oxygen tank. The oxygen hose reel assembly can further comprise a quick-release hose reel allowing for quick maintenance and replacement of old or damaged hose with a new oxygen hose.

In another aspect, an oxygen hose reel assembly of the present invention can comprise an automated mechanical and/or electrical system for retracting and dispensing the oxygen hose. The oxygen hose reel assembly can comprise a line release mechanism wherein a patient or caregiver can selectively choose a desired rate for the oxygen hose to be dispensed form the hose reel assembly. The line release mechanism can play out additional oxygen hose upon the recognition of unsafe forces such as, for example, torque, on the oxygen hose as detected by sensors in the oxygen hose reel assembly. The oxygen hose reel assembly can further comprise a line recoil mechanism for coiling excess or slack oxygen hose as directed by a patient or caregiver. The line recoil mechanism can comprise recoil safety mechanisms such as, for example, an interrupt system and/or torque limiting system, such that line recoil does not transmit or inflict uncomfortable and/or unsafe conditions on the patient.

In another aspect, an oxygen hose reel assembly of the present invention provides a patient and/or caregiver with a convenient control package for selectively dispensing or retrieving oxygen hose. The control package can comprise a hand operated control using control interfaces such as, for example, buttons and knobs to operate the oxygen hose reel assembly. The control package can comprise a wireless protocol such as, for example, Radio Frequency circuitry, Infrared Circuitry, Bluetooth and other suitable wireless protocols such that wiring between the control package and the oxygen hose reel assembly can be eliminated. In an alternative embodiment, the control package can comprise a voice activated protocol allowing the patient and/or caregiver to control the oxygen hose reel assembly through voice commands.

In another aspect, the oxygen hose reel assembly can comprise a rechargeable battery system such that the increased functional and safety characteristics of the assembly can accompany a patient during daily activities. The oxygen hose reel assembly can comprise an integral battery charging cord allowing the battery pack to be recharged at home, in a car or any other place an electrical outlet or receptacle is accessible.

The above summary of the various representative embodiments of the disclosure is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a perspective, front view of an embodiment of an oxygen hose reel of the present invention.

FIG. 2 is a perspective, rear view of the oxygen hose reel of FIG. 1.

FIG. 3 is a bottom view of the oxygen hose reel of FIG. 1.

FIG. 4 is an exploded perspective view of the oxygen hose reel of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

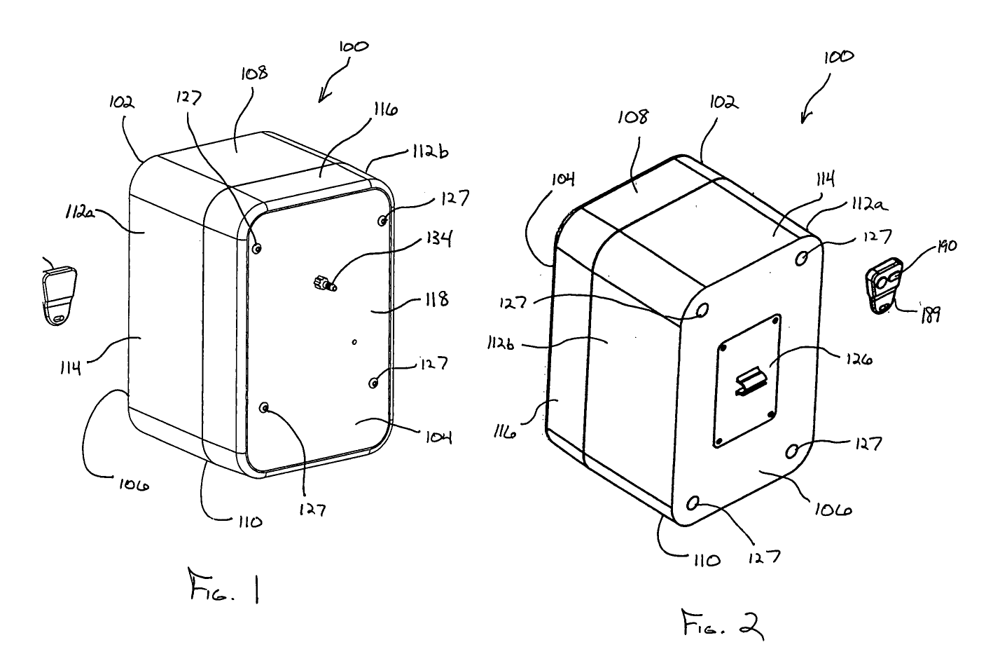

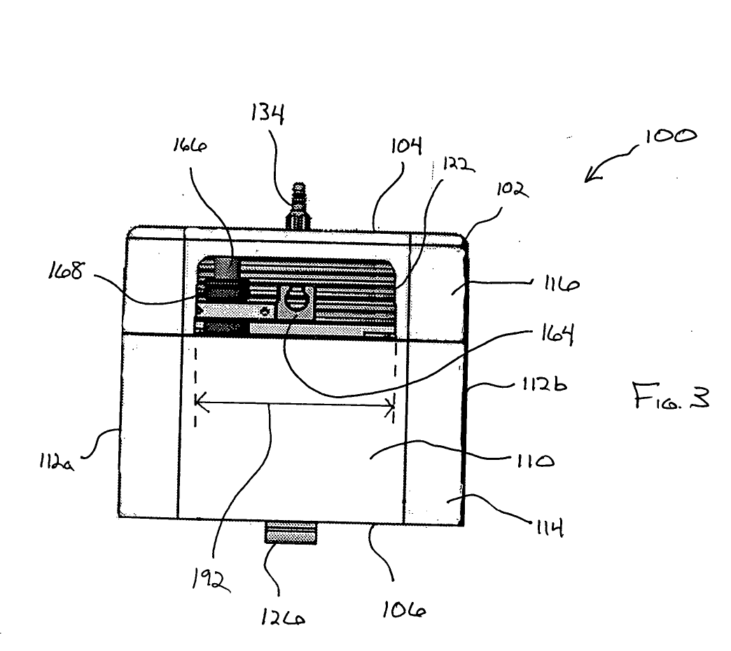

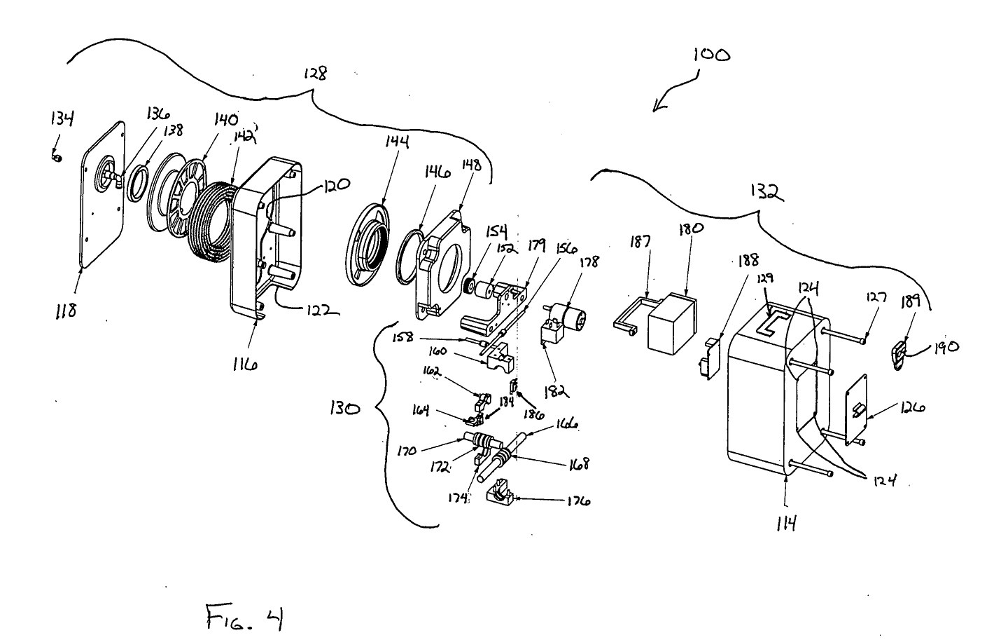

A representative embodiment of an oxygen hose reel assembly 100 is illustrated in FIGS. 1, 2, 3 and 4. Oxygen hose reel assembly 100 generally comprises a body 102 defining a front surface 104, rear surface 106, top surface 108, bottom surface 110 and a pair of sides 112a, 112b. Body 102 generally comprises a base enclosure 114, a cover 116 and an access lid 118. Cover 116 can comprise a reel mounting knockout 120 and a drive access cutaway 122. Base enclosure 114 can comprise mounting bores 124 for removably attaching a bracket assembly 126. Bracket assembly 126 can comprise a variety of configurations depending upon where the oxygen hose reel assembly 100 is to be mounted such as, for example, on a wheelchair, a bed, an oxygen tank or an oxygen concentrator. In an alternative embodiment, a strap assembly can be attached to bracket assembly 126 such that oxygen hose reel assembly 100 can be attached to and worn by a patient. Suitable strap assemblies can make use of a variety of fastening assemblies such as, for example, a hook and loop fastener as well as snap, button or buckle assemblies, for securing the strap assembly to the patient. As best illustrated in FIG. 3, a variety of fasteners 127 such as, for example, screws can be used to assembly oxygen hose reel assembly 100.

Body 102 can be fabricated of suitable materials such as, for example, metals such as aluminum, stainless steel and the like or plastics such as, for example, ABS (Acrylonitrile Butadiene Styrene), polycarbonate, polyester and the like. In a preferred embodiment, body 102 is fabricated of impact resistant, lightweight materials that allow a patient and/or caregiver to conveniently and safely pick-up and position the oxygen hose reel assembly 100 in desired locations. Body 102 can further comprise a handle assembly 129 as illustrated in FIG. 4 either molded as part of the body 102 or suitably attached to the exterior of body 102 to assist in transporting the oxygen hose reel assembly 100.

As illustrated in FIG. 4, oxygen hose reel assembly 100 generally comprises a reel assembly 128, a drive assembly 130 and a control assembly 132. Reel assembly 128 can comprise a hose fitting 134, a hose elbow 136, first bearing 138, a hose reel 140, coiled oxygen hose 142, a gear mount 144, a second bearing 146 and a reel mount 148. Drive assembly 130 can comprise a magnetic clutch 152, a gear 154, a first bearing shaft 156, a second bearing shaft 158, a top clamp 160, a top ring clamp 162, a ring 164, a limit guide shaft 166, a limit bushing 168, a dispensing guide shaft 170, a dispensing bushing 172, a bottom ring clamp 174, a bottom clamp 176, a motor 178 and a motor mount 179. Control assembly 132 can comprise a rechargeable battery pack 180, a relay 182, a first limit switch 184, a second limit switch 186, battery hold down bracket 187, a receiver 188 and a controller 189. Rechargeable battery pack 180 can comprise a suitable rechargeable battery such as, for example, Nickel-Cadmium (Ni—Cd) batteries, Nickel-Metal Hydride (Ni-MH) batteries and Lithium and Lithium Ion batteries. Rechargeable battery pack 180 can include a plug assembly mounted to the body 102 to allow for convenient recharging with a suitable electrical outlet. Receiver 188 generally comprises an integrated circuit design and can include a microprocessor, terminal blocks, wireless receiver and similar electronic components. Controller 189 generally comprises a wireless controller having inputs such as switches or buttons 190 and a wireless transmitter for communicating inputs to the receiver 188. Controller 189 can communicate with the receiver 188 using suitable wireless communication protocols including RF (Radio Frequency) transmission, Bluetooth, Infrared and similar communication protocols.

For purposes of illustration, use of oxygen hose reel assembly 100 will be described with reference to a bed. This description is not intended to be limiting but instead, it will be understood that oxygen hose reel assembly 100 can be suitably positioned in a variety of different locations such as, for example, mounted on a wheelchair or attached to an oxygen concentrator or tank, without departing from the spirit and scope of the present invention.

In use with a bed, oxygen hose reel assembly 100 can be positioned on a bed rail, headboard, foot rail or other structural component using the bracket assembly 126. An oxygen supply hose interconnects the hose fitting 134 to an oxygen supply such as, for example, an oxygen tank and/or oxygen concentrator. Hose fitting 134 and hose elbow 136 operably interconnect the coiled oxygen hose 142 with the oxygen supply such that oxygen gas can be delivered to the patient. To supply oxygen to the patient, a supply end of the coiled oxygen hose 142 is positioned within ring 164 and fed through the hose dispensing cutaway 122 wherein the supply end can be attached to a nasal oxygen cannula.

In dispensing the coiled oxygen hose 142 from the oxygen hose reel assembly 100, the dispensing process can be accomplished manually by pulling on the coiled oxygen hose 142. Alternatively, the dispensing process can be accomplished automatically through use of the controller 189. Using controller 189, a patient or caregiver can transmit a signal to the receiver 188 directing the oxygen hose reel assembly 100 that a length of oxygen hose 142 is to be dispensed or “played out”. Receiver 188 electrically communicates with the relay 182 such that motor 178 is actuated such that gear 154 spins in a dispensing direction wherein hose reel 140 is turned so as to play out oxygen hose 142. Controller 189 can provide the patient or caregiver with the ability to control the rate at which oxygen hose reel assembly 100 dispenses the oxygen hose 142 by varying the rate at which motor 178 spins the hose reel 140. Oxygen hose 142 is directed out the hose dispensing cutaway 122 wherein the patient or caregiver can attach a nasal oxygen cannula and position the cannula in proximity to the nose for breathing oxygen. Using controller 189, the patient or caregiver can direct the motor 178 to dispense additional oxygen hose 142 if additional slack is desired or to retrieve oxygen hose 142 in the event that too much hose has been dispensed or if the activity requiring the additional oxygen hose 142 has been completed and the patient wishes to recoil the oxygen hose 142.

When oxygen hose 142 is dispensed and delivering oxygen to a patient, first limit switch 184 and second limit switch 186 serve to monitor and prevent unsafe or uncomfortable situations from developing with respect to tension and/or torque in the oxygen hose 142 that would ultimately be experienced by the patient. First limit switch 184 and second limit switch 186 are mounted at the sides of the hose dispensing cutaway 122 so as to define an operational range 192 illustrated in FIG. 3 for the oxygen hose 142. The hose dispensing cutaway 122, first bearing shaft 156, second bearing shaft 158, top clamp 160, top ring clamp 162, limit guide shaft 166, limit bushing 168, dispensing guide shaft 170, dispensing bushing 172, bottom ring clamp 174, bottom clamp 176 cooperatively function to maintain ring 164 and correspondingly, the oxygen hose 142 within operational plane 192. When forces are translated to oxygen hose 142, the ring 164 slides within this operational plane 192 wherein the first limit switch 184 and second limit switch 186 serve as the end points defining the operational plane 192. If the ring 164 and oxygen hose 142 slides and contacts the first limit switch 184 and/or the second limit switch 186, a signal is transmitted to receiver 188 which immediately communicates with the relay 182 and consequently the motor 178, wherein the motor 178 can be actuated so as to dispense additional oxygen hose 142 to relieve the forces on the oxygen hose 142. In this manner, unsafe conditions wherein oxygen delivery can be interrupted or terminated such as, for example, by a kinked oxygen hose 142, or in some instances where the nasal oxygen cannula can be painfully ripped away from the patient, are prevented. These unsafe conditions can be caused when a patient rolls over while sleeping, a patient moving about their home gets the oxygen hose 142 caught around a doorway or piece of furniture or in similar situations. In addition, when first limit switch 184 and second limit switch 186 are tripped, a patient or caregiver is prevented from using controller 189 to initiate recoil of the oxygen hose 142 that could further aggravate the forces acting on the oxygen hose 142.

Over extended periods of use, oxygen hose 142 can become brittle and require replacement. To replace oxygen hose 142, access lid 118 is removed and a rotary coupler on the hose reel 140 allows the hose reel 140 to be quickly removed. At this point, a new oxygen hose 142 can be wound about the hose reel 140 and attached to the hose elbow 136 and fed through the hose dispensing cutaway 122 for use, or alternatively, a second pre-wound hose reel can be installed.

In an alternative embodiment, controller 189 can comprise a voice-activated controller allowing a patient or caregiver to give voice commands to the oxygen hose reel assembly 100 for initiating the release or retraction of oxygen hose 142.

The present disclosure describes aspects of an oxygen hose reel assembly for providing desirable features related to functionality and safety. It will be understood by one of skill in the art that additional, alternative embodiments are contemplated and would not depart from the spirit and scope of the present disclosure.

What is claimed:

1. A portable oxygen hose reel comprising:
a housing enclosing a reel assembly, a drive assembly and a control assembly, the reel assembly including a wrapped length of the tubing, the drive assembly having a motor rotatably operably connected to the reel assembly, the control assembly having a control board, a controller and a battery pack, and
wherein the control board operably directs the motor to turn the reel assembly to selectively retrieve the tubing.

2. The portable oxygen hose reel of claim 1, wherein the housing includes a bracket assembly adapted for attachment to a wheelchair, a bed, an oxygen tank, an oxygen concentrator and a wearable strap.

3. The portable oxygen hose reel of claim 1, wherein the battery pack is a rechargeable battery pack.

4. The portable oxygen hose reel of claim 1, wherein the control board operably directs the motor to dispense tubing based upon an automatically sensed force on the tubing, the automatically sensed force being sensed by at least one limit switch in the control assembly that is operably connected to the control board.

5. The portable oxygen hose reel of claim 1, wherein the control board operably prevents the motor from recoiling tubing based upon an automatically sensed force on the tubing, the automatically sensed force being sensed by at least one limit switch in the control assembly that is operably connected to the control board.

6. The portable oxygen hose reel of claim 1, wherein the reel assembly includes a removable hose reel.

7. The portable oxygen hose reel of claim 1, wherein the control assembly includes a wireless receiver operably connected to the control board and the controller comprises a wireless transmitter, the controller having one or more input interfaces wherein a wireless signal is communicated to the control board for operably controlling the drive assembly.

8. The portable oxygen hose reel of claim 7, wherein the wireless signal is selected from a wireless protocol selected form the group consisting of: Radio Frequency, Bluetooth and Infrared.

9. A method for dispensing and retracting a length of oxygen tubing comprising:
providing a control assembly having a control board and a controller, wherein the control board is operably connected to a drive assembly; and
directing a motor in the drive assembly to selectively, rotatably drive a hose reel assembly, wherein a length of oxygen tubing is selectively dispensed or retraced from the hose reel assembly.

10. The method of claim 9, further comprising:
sensing a force on the length of oxygen tubing with a sensor in the control assembly, the sensor communicating the force to the control board.

11. The method of claim 9, further comprising:
dispensing an additional amount of oxygen tubing based upon the sensed forced, said dispensing occurring without an input to the controller.

12. The method of claim 9, further comprising:
preventing the recoil of any oxygen tubing based upon the sensed force.

13. The method of claim 9, further comprising:
interfacing with the controller to provide an input to the control board for selectively controlling the drive assembly.

14. The method of claim 13, wherein providing the input to the control board includes wirelessly transmitting the input from a transmitter in the controller to a receiver in the control assembly, the receiver being operably connected to the control board.

15. The method of claim 9, further comprising:
enclosing the control assembly, the drive assembly and the hose reel assembly in a portable housing.

16. The method of claim 15, further comprising:
mounting the portable housing at a point of use with a bracket assembly on the portable housing, the bracket assembly adapter for attachment to points of use selected from the group consisting of:
a wheelchair, a bed, an oxygen tank, an oxygen concentrator and a wearable strap.

17. The method of claim 9, further comprising:
recharging a battery in the control assembly.

18. The method of claim 9, further comprising:
inspecting the length of oxygen tubing for defects in the oxygen tubing, whereupon the hose reel assembly can be replaced with a second hose reel assembly upon discovery of defects.

19. A portable oxygen hose reel comprising:
a housing enclosing a reel assembly, a drive assembly and a control assembly, the reel assembly including a wrapped length of the tubing, the drive assembly having a motor rotatably operably connected to the reel assembly, the control assembly having a control board, a controller, a battery pack and a means for sensing tubing forces, the control board being operably connected to the motor, and wherein the means for sensing tubing forces continually senses forces on the tubing and wherein the means for sensing forces communicates with the control board to selectively direct the motor to dispense or prevent retraction of the tubing based on the sensed forces.

20. The portable oxygen hose reel of claim 19, wherein the means for sensing tubing forces comprises a pair of limit switches in the control assembly defining an operational plane wherein the tubing resides, and wherein contact between the tubing and either of the limit switches initiates communication with the control board.
